(19) United States
(12) Patent Application Publication
(10) Pub. No.: US 2012/0062552 A1
(43) Pub. Date: Mar. 15, 2012

(54) METHOD OF PROCESSING IMAGE DATA AND DISPLAY APPARATUS PERFORMING THE METHOD

(75) Inventors: Jae-Sung BAE, Suwon-si (KR); Bong-Hyun YOU, Yongin-si (KR); Jai-Hyun KOH, Seoul (KR)

(73) Assignee: SAMSUNG ELECTRONICS CO., LTD., Suwon-si, (KR)

(21) Appl. No.: 13/198,112

(22) Filed: Aug. 4, 2011

(30) Foreign Application Priority Data
Sep. 9, 2010 (KR) 2010-0088343

(51) Int. Cl. G06T 15/00; G06T 3/40

(52) U.S. Cl. 345/419; 345/428

(57) ABSTRACT

A method of processing an image data includes generating a data frame that has a resolution of a high resolution using an original image data of a low resolution and outputting M (herein, M is a natural number not less four) data frames using the data frame of the high resolution. The original image data frame having the low resolution is processed into the image frame having the high resolution so that an image of the high resolution may be displayed on the display panel having the high resolution.

This application claims priority to Korean Patent Application No. 2010-88343, filed on Sep. 9, 2010, and all the benefits accruing therefrom under 35 U.S.C. §119, the contents of which in its entirety are herein incorporated by reference.

### BACKGROUND OF THE INVENTION

1. Field of the Invention

Exemplary embodiments of the present invention relate to a method of processing image data and a display apparatus performing the method. More particularly, exemplary embodiments of the present invention relate to a method of processing image data for displaying an image of a high resolution and a display apparatus for performing the method.

2. Description of the Related Art

A liquid crystal display (“LCD”) is a flat display panel (“FDP”) and has been employed in various display apparatus to secure a foothold in the market. The LCD includes two glass substrates and liquid crystal (“LC”) disposed between two glass substrates, herein LC is intermediate material between liquid and solid. The LC is arranged by a field intensity formed between two glass substrates. Thus, the LCD displays an image such as a figure, a character, a picture, etc. by changing an arrangement of the LC. Generally, the LCD has a slow response time, a low resolution and a narrow viewing angle so that the LCD is difficult to employ in a large screen. Currently, according to the development of wide viewing angle technology, large screen technology, full high definition (“FHD”) technology, etc, the LCD has been employed in a large-sized television (“TV”).

According to the LCD having a large size, a trend for an image has been transited from an image of the FHD to an image of an ultra-high definition (“UD”) and from a 2-dimensional (“2D”) image to a 3-dimensional (“3D”) image. The LCD panel has been developed for the UD according to the trend for the image, and the LCD panel for the UD has a resolution of about 4 times larger than that of the FHD. However, contents of the 2D image and the 3D image for the UD are lack so that the trend for the image is blocked by lack of contents.

### BRIEF SUMMARY OF THE INVENTION

Exemplary embodiments of the present invention provide a method of processing image data in order to process an original image data of a low resolution into an image data of a high resolution.

Exemplary embodiments of the present invention also provide a display apparatus for performing the above-mentioned method.

According to an exemplary embodiment of the present invention, there is provided a method of processing image data for displaying an image of the high resolution. In the method, a data frame that has a high resolution is generated using an original image data of a low resolution. M (herein, M is a natural number not less than 4) data frames are outputted using the data frame of the high resolution.

In an exemplary embodiment, outputting M data frames includes scaling left-eye data of the data frame into a left-eye data frame of the high resolution, outputting the left-eye data frame into N (herein, N is a natural number and is M/2) left-eye data frames, scaling right-eye data of the data frame into a right-eye data frame of the high resolution and outputting the right-eye data frame into N right-eye data frames.

In an exemplary embodiment, the method further includes generating a black data frame that is respectively inserted between the left-eye data frame and the right-eye data frame.

According to another exemplary embodiment of the present invention, a display apparatus includes a display panel, an image data processing part and a panel driving part. The display panel includes a plurality of pixel units corresponding to a high resolution. The image data processing part generates a data frame of the high resolution using an original data frame of a low resolution and outputting M (herein, M is a natural number not less than 4) data frames using the data frame of the high resolution. The panel driving part displays M frame images on the display panel using the M data frames.

In an exemplary embodiment, the image data processing part includes a scaler generating the data frame of the high resolution using the original data frame and a frame rate control part outputting M data frames using the data frame of the high resolution.

In an exemplary embodiment, the frame rate control part scales left-eye data of the data frame into a left-eye data frame of the high resolution, outputs the left-eye data frame into N (herein, N is a natural number and is M/2) left-eye data frames, scales right-eye data of the data frame into a right-eye data frame of the high resolution, and outputs the right-eye data frame into generate N right-eye data frames.

In an exemplary embodiment, the image data processing part further includes the timing control part generating a black data frame that is respectively inserted between the left-eye data frame and the right-eye data frame.

According to exemplary embodiments of the present invention, the original image data frame having the low resolution is processed into the image frame having the high resolution so that an image of the high resolution may be displayed on the display panel having the high resolution.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is block diagram illustrating an exemplary embodiment of a display apparatus according to the present invention;

FIG. 2 is a schematic diagram showing an exemplary embodiment of a method of processing three-dimensional (“3D”) image data using the exemplary image data processing part of FIG. 1;

FIG. 3 is a schematic diagram showing another exemplary embodiment of a method of processing 3D image data using the exemplary image data processing part of FIG. 1;

FIG. 4 is a schematic diagram showing another exemplary embodiment of a method of processing 3D image data using the image data processing part of FIG. 1;

FIG. 5 is a schematic diagram showing another exemplary embodiment of a method of processing 3D image data using the image data processing part of FIG. 1;

FIG. 6 is a schematic diagram showing an exemplary embodiment of a method of processing two-dimensional (“2D”) image data using the image data processing part of FIG. 1;

FIG. 7 is a block diagram illustrating another exemplary embodiment of an image data processing part according to the present invention;

FIG. 8 is a schematic diagram showing an exemplary embodiment of a method of processing 3D image data using the exemplary image data processing part of FIG. 7;

FIG. 9 is a schematic diagram showing another exemplary embodiment of a method of processing 3D image data using the image data processing part of FIG. 7;

FIG. 10 is a schematic diagram showing another exemplary embodiment of a method of processing 3D image data using the image data processing part of FIG. 7;

FIG. 11 is a schematic diagram showing another exemplary embodiment of a method of processing 3D image data using the image data processing part of FIG. 7; and

FIG. 12 is a schematic diagram showing yet another exemplary embodiment of a method of processing 2D image data using the image data processing part of FIG. 7.

### DETAILED DESCRIPTION OF THE INVENTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, the present invention will be explained in detail with reference to the accompanying drawings.

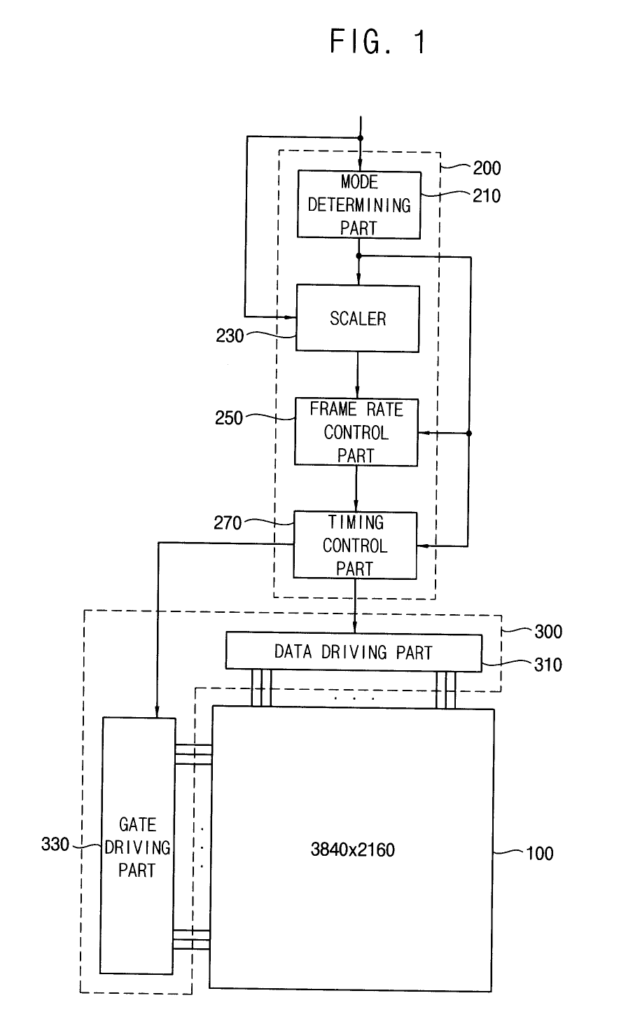

FIG. 1 is block diagram illustrating an exemplary embodiment of a display apparatus according to the present invention.

Referring to FIG. 1, the display apparatus includes a display panel 100, an image data processing part 200 and a panel driving part 300.

The display panel 100 includes a plurality of pixel units. Each of the pixel units includes a plurality of color sub pixels. The display panel 100 may have a resolution that is higher than or equal to a resolution of the original image data. The image data processing part 200 processes the original image data into an image data having a resolution corresponding to the display panel 100. For example, when the original image data has a low resolution and the display panel 100 has a high resolution higher than the low resolution, the image data processing part 200 processes the original image data of the low resolution into the image data of the high resolution. Hereinafter, the low resolution of the original image data may be referred to as a full high definition (“FHD”) and the high resolution of the display panel 100 may be referred to as an ultra definition (“UD”). Alternatively, the resolution of the original image data and the display panel 100 may be referred to as the UD. The resolution of the original image data and the display panel 100 may be preset variously.

The image data processing part 200 includes a mode determining part 210, a scaler 230, a frame rate control part 250 and a timing control part 270.

The mode determining part 210 receives an original data of an original data frame and determines an image mode of the original data frame. In an exemplary embodiment, the mode determining part 210 determines the image mode of the original data frame using a synchronization signal, a mode information signal, etc. That is, the original data frame determines whether the original image data is a 2D image mode or a 3D image mode. The 2D image mode includes a 2D image mode of the UD and a 2D image mode of the FHD. The 3D image mode includes a 3D image mode of the UD and a 3D image mode of the FHD. The original data frame of the 3D image may be a compression image data including left-eye image data and right-eye image data. A compression type of the compression image data may include a side-by-side type, a vertical interleave type, a horizontal interleave type, a top-bottom type, a checker type, etc. Hereinafter, the 3D original image data compressed by the side-by-side type will be explained.

The scaler 230 scales the original data frame based on the image mode determined from the mode determining part 210 so that the resolution of the original data frame is increased into the resolution of the UD that is the resolution of the display panel 100. When the original data frame is the FHD image mode, the scaler 230 scales up the original data frame into a data frame of the UD. When the original data frame is the UD, the scaler 230 bypasses the original data frame to output a data frame of the UD.

The frame rate control part 250 outputs a plurality of data frames using the data frame scaled from the scaler 230 according to the image mode. For example, the frame rate control part 250 may repeat the received data frame to output a plurality of data frames. Alternatively, the frame rate control part 250 may interpolate a data frame for an interpolation between a previous data frame and a present data frame using a motion estimation and motion compensation (“MEMC”) method to output a plurality of data frames including the data frame for the interpolation and the present data frame for an original.

In the 2D image mode, the frame rate control part 250 outputs M (herein, M is a natural number not less than 4) data frames using the scaled data frame from the scaler 230. In the 3D image mode, the frame rate control part 250 time-divides the scaled data frame into left-eye image data and right-eye image data, and scales up each of the left-eye and right-eye image data into a data frame of the UD. The frame rate control part 250 outputs the scaled left-eye data frame into N (herein, N is a natural number and is M/2) left-eye data frames and outputs the scaled right-eye data frame into N right-eye data frames.

In an exemplary embodiment, when the image mode of the original data frame is the 2D image mode, the frame rate control part 250 outputs 4 data frames of 240 Hz using the original data frame of 60 Hz. Hereinafter, a data frame of 60 Hz is displayed on the display panel 100 with 60 Hz and a data frame of 240 Hz is displayed on the display panel 100 with 240 Hz. When the image mode of the original data frame is the 3D image mode, the frame rate control part 250 divides the original data frame of 60 Hz into left-eye image data and right-eye image data, scales the left-eye image data and right-eye image data into a left-eye data frame of the UD and a right-eye data frame of the UD. The frame rate control part 250 outputs the left-eye data frame into 2 left-eye data frames and outputs the right-eye data frame into 2 right-eye data frames.

The timing control part 270 provides a plurality of data frames received from the frame rate control part 250 to the data driving part 310 based on the image mode. In the 2D image mode, the timing control part 270 provides the M data frames to the data driving part 310. In the 3D image mode, the timing control part 270 generates a black data frame and inserts the black data frame between the left-eye data frame and the right-eye data frame. For example, the timing control part 270 may sequentially output (N−1) left-eye data frames, a first black data frame, (N−1) right-eye data frames and a second black data frame.

The panel driving part 300 displays a frame image of the UD on the display panel 100 using the data frame and a control signal received from the timing control part 270. The panel driving part 300 includes a data driving part 310 providing a data signal to a data line of the display panel 100 and a gate driving part 330 providing a gate signal to a gate line of the display panel 100.

In an exemplary embodiment, in the 2D image mode, the panel driving part 300 displays M frame images corresponding to the original data frame on the display panel 100. In the 3D image mode, the panel driving part 300 displays (N−1) left-eye frame images, a first black frame image, (N−1) right-eye frame images and a second black frame image corresponding to the original data frame on the display panel 100.

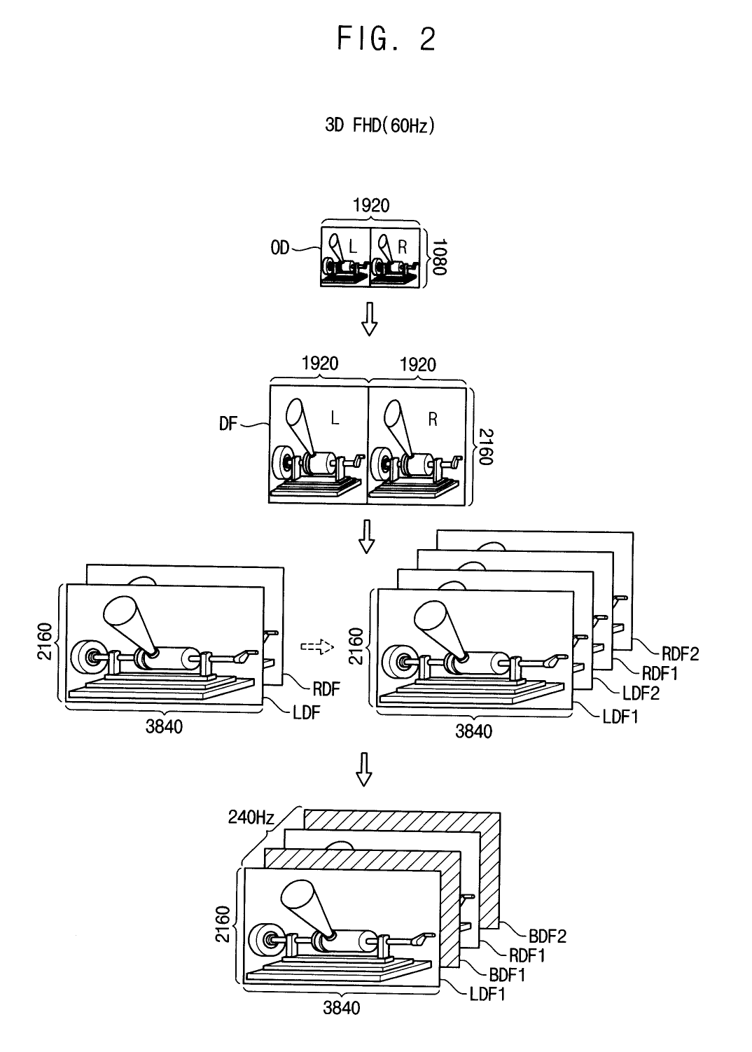

FIG. 2 is a schematic diagram showing an exemplary embodiment of a method of processing 3D image data using the exemplary image data processing part 200 of FIG. 1. Hereinafter, the FHD is referred to as a resolution of 1920×1080 and the UD is referred to as a resolution of 3840×2160.

Referring to FIGS. 1 and 2, the mode determining part 210 determines that the original data frame OD is the 3D image mode that is 60 Hz and has a resolution of the FHD. Accordingly, the mode determining part 210 controls the scaler 230, the frame rate control part 250 and the timing control part 270.

The scaler 230 scales up the original data frame OD of the FHD in horizontal and vertical directions to generate a data frame DF having the resolution of the UD and provides the data frame DF to the frame rate control part 250. The original data frame OD includes left-eye image data L and right-eye image data R so that the data frame DF includes the left-eye image data L and the right-eye image data R.

The frame rate control part 250 time-divides the data frame DF into the left-eye image data L and the right-eye image data R and respectively scales up the left-eye image data L and the right-eye image data R to generate a left-eye data frame LDF and a right-eye data frame RDF of the UD. The frame rate control part 250 repeats the left-eye data frame LDF to output a first left-eye data frame LDF1 and a second left-eye data frame LDF2. The frame rate control part 250 repeats the right-eye data frame RDF to output a first right-eye data frame RDF1 and a second right-eye data frame RDF2. The frame rate control part 250 outputs the first left-eye data frame LDF1, the second left-eye data frame LDF2, the first right-eye data frame RDF1 and the second right-eye data frame RDF2 of 240 Hz to the timing control part 270.

Alternatively, the frame rate control part 250 may output the first left-eye data frame LDF1 for the interpolation, the second left-eye data frame LDF2 for the original, the first right-eye data frame RDF1 for the interpolation and the second right-eye data frame RDF2 for the original of 240 Hz to the timing control part 270 using the MEMC method.

The timing control part 270 receives the first left-eye data frame LDF1, the second left-eye data frame LDF2, the first right-eye data frame RDF1 and the second right-eye data frame RDF2 from the frame rate control part 250. The timing control part 270 generates a black data frame BDF to insert between the left-eye data frame LDF and the right-eye data frame RDF. Thus, the timing control part 270 sequentially outputs the first left-eye data frame LDF1, a first black data frame BDF1, a first right-eye data frame RDF1 and a second black data frame BDF2 to the data driving part 310.

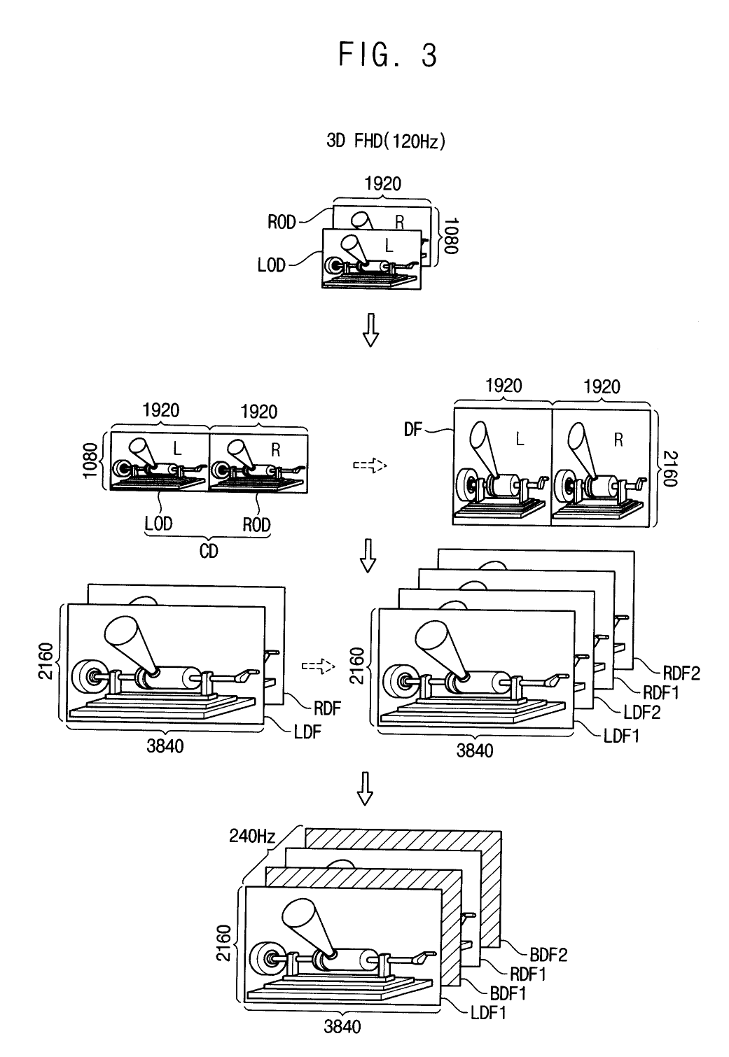

FIG. 3 is a schematic diagram showing another exemplary embodiment of a method of processing 3D image data using the image data processing part of FIG. 1.

Referring to FIGS. 1 and 3, the mode determining part 210 determines that the original data frame OD is the 3D image mode that is a data frame of 120 Hz and has the resolution of the FHD. Accordingly, the mode determining part 210 controls the scaler 230, the frame rate control part 250 and the timing control part 270.

The scaler 230 stores the left-eye original data frame LOD and the right-eye original data frame ROD of 120 Hz, composes the left-eye original data frame LOD with the right-eye original data frame ROD, and scales up the composed image data CD into a data frame DF of the UD, and provides the data frame DF to the frame rate control part 250.

The frame rate control part 250 time-divides the data frame DF into the left-eye image data L and the right-eye image data R, and respectively scales up the left-eye image data L and the right-eye image data R into a left-eye data frame LDF and a right-eye data frame RDF. The frame rate control part 250 outputs the left-eye data frame LDF into a first left-eye data frame LDF1 and a second left-eye data frame LDF2. The frame rate control part 250 outputs the right-eye data frame RDF into a first right-eye data frame RDF1 and a second right-eye data frame RDF2. Alternatively, the frame rate control part 250 may output the first left-eye data frame LDF1 for the interpolation, the second left-eye data frame LDF2 for the original, the first right-eye data frame RDF1 for the interpolation and the second right-eye data frame RDF2 for the original of 240 Hz to the timing control part 270 using the MEMC method.

The frame rate control part 250 outputs the first left-eye data frame LDF1, the second left-eye data frame LDF2, the first right-eye data frame RDF1 and the second right-eye data frame RDF2 of 240 Hz to the timing control part 270.

The timing control part 270 receives the first left-eye data frame LDF1, the second left-eye data frame LDF2, the first right-eye data frame RDF1 and the second right-eye data frame RDF2 from the frame rate control part 250 and generates a black data frame BDF to insert between the left-eye data frame LDF and the right-eye data frame RDF. Thus, the timing control part 270 sequentially outputs the first left-eye data frame LDF1, the first black data frame BDF1, the first right-eye data frame RDF1 and the second black data frame BDF2 to the data driving part 310.

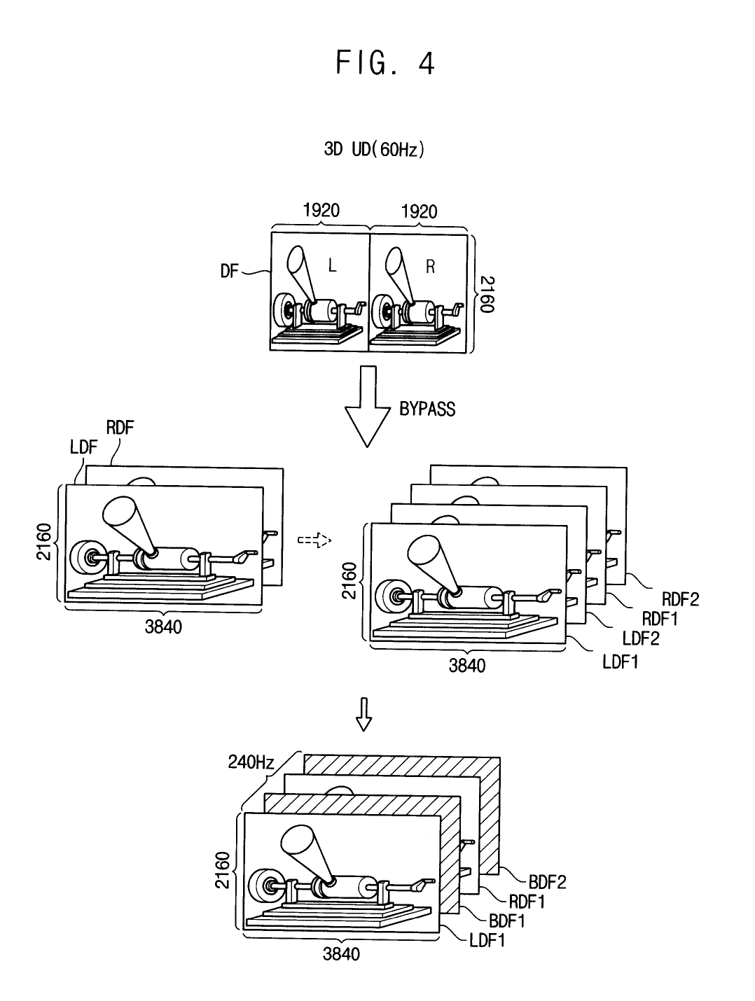

FIG. 4 is a schematic diagram showing another exemplary embodiment of a method of processing 3D image data using the image data processing part of FIG. 1.

Referring to FIGS. 1 and 4, the mode determining part 210 determines that the 3D image mode is 60 Hz and has the resolution of the UD. Accordingly, the mode determining part 210 controls the scaler 230, the frame rate control part 250 and the timing control part 270.

The mode determining part 210 bypasses the scaler 230 and provides the original data frame OD to the frame rate control part 250 as it is because the resolution of the original data frame OD is substantially same as that of the display panel 100 having the UD. The original data frame OD includes the left-eye image data L and the right-eye image data R as the data frame DF of the UD.

The frame rate control part 250 time-divides the data frame DF into the left-eye image data L and the right-eye image data R, and respectively scales up the left-eye image data L and the right-eye image data R to generate a left-eye data frame LDF and a right-eye data frame RDF of the UD. The frame rate control part 250 repeats the left-eye data frame LDF to output a first left-eye data frame LDF1 and a second left-eye data frame LDF2. The frame rate control part 250 repeats the right-eye data frame RDF to output a first right-eye data frame RDF1 and a second right-eye data frame RDF2. The frame rate control part 250 outputs the first left-eye data frame LDF1, the second left-eye data frame LDF2, the first right-eye data frame RDF1 and the second right-eye data frame RDF2 of 240 Hz to the timing control part 270. Alternatively, the frame rate control part 250 may output the first left-eye data frame LDF1 for the interpolation, the second left-eye data frame LDF2 for the original, the first right-eye data frame RDF1 for the interpolation and the second right-eye data frame RDF2 for the original of 240 Hz to the timing control part 270 using the MEMC method.

The timing control part 270 receives the first left-eye data frame LDF1, the second left-eye data frame LDF2, the first right-eye data frame RDF1 and the second right-eye data frame RDF2 and generates a black data frame BDF to insert between the left-eye data frame LDF and the right-eye data frame RDF. Thus, the timing control part 270 sequentially outputs the first left-eye data frame LDF1, the first black data frame BDF1, the first right-eye data frame RDF1 and the second black data frame BDF2 to the data driving part 310.

Meanwhile, when the original data frame OD is the 3D image mode that is a data frame of 120 Hz and has the resolution of the UD, the scaler 230 stores the left-eye original data frame and the right-eye original data frame of the UD. In one exemplary embodiment, the scaler 230 composes the left-eye original data frame with right-eye original data frame and scales down the composed image data into the data frame of the UD. In an alternative exemplary embodiment, the scaler 230 scales down the left-eye original data frame and the right-eye original data frame and composes the scaled left-eye original data frame with the scaled right-eye original data frame to generate the composed image data of the UD. The frame rate control part 250 and the timing control part 270 are driven substantially the same as described above referring to FIG. 4.

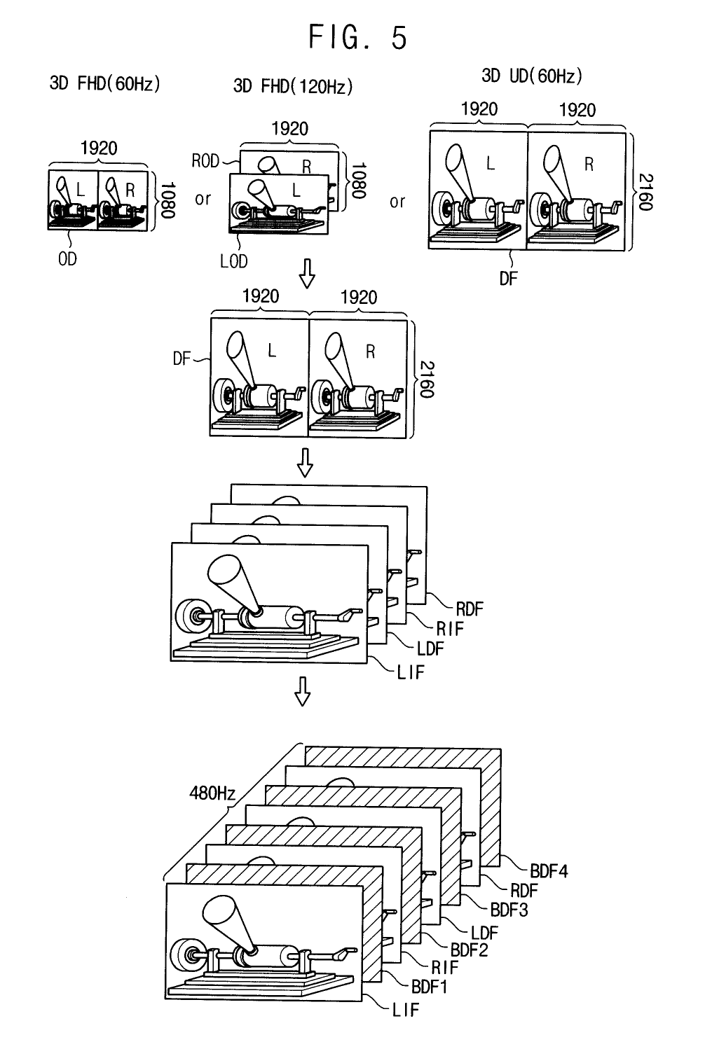

FIG. 5 is a schematic diagram showing another exemplary embodiment of a method of processing 3D image data using the image data processing part of FIG. 1. Hereinafter, the same reference numerals will be used to refer to the same or like parts as those described in the previous example embodiment, and any repetitive detailed explanation will be simplified.

Referring to FIGS. 1 and 5, the mode determining part 210 controls a scaler 230, a frame rate control part 250 and a timing control part 270 according to an image mode of the received original image data,

The original image data may be at least one of the 3D FHD of 60 Hz, the 3D FHD of 120 Hz and the 3D UD of 60 Hz as described above with reference to FIGS. 2, 3 and 4.

When the original image data is the 3D FHD as described above with reference to FIG. 2 or 3, the scaler 230 scales the original image data into a data frame of the UD. Alternatively, when the original image data is the data frame DF of the UD, the scaler 230 bypasses the original data frame to output a data frame of the UD.

The frame rate control part 250 time-divides the data frame DF into the left-eye image data L and the right-eye image data R, and scales up the left-eye image data L and the right-eye image data R to generate a left-eye data frame LDF and a right-eye data frame RDF of the UD respectively.

The frame rate control part 250 generates a left-eye data frame LIF for an interpolation and a right-eye data frame RIF for an interpolation respectively corresponding to the left-eye data frame LDF and the right-eye data frame RDF by the MEMC method. For example, the frame rate control part 250 interpolates a data frame the interpolation between the previous data frame and the present data frame using the MEMC method to output the data frame for the interpolation and the present data frame for an original.

Therefore, the frame rate control part 250 outputs the left-eye data frame LIF for the interpolation, the left-eye data frame LDF for the original, the right-eye data frame RIF for the interpolation and the right-eye data frame RDF for the original.

The timing control part 270 generates a black data frame and inserts the black data frame between the left-eye data frame LIF for the interpolation, the left-eye data frame LDF for the original, the right-eye data frame RIF for the interpolation and the right-eye data frame RDF for the original. For example, the timing control part 270 sequentially outputs the left-eye data frame LIF for the interpolation, a first black data frame BDF1, the left-eye data frame LDF for the original, a second black data frame BDF2, the right-eye data frame RIF for the interpolation, a third black data frame BDF3, the right-eye data frame RDF for the original and a fourth black data frame BDF4.

Accordingly, the display panel 100 may sequentially display a left-eye image for the interpolation, a black image, a right-eye image for the interpolation, the black image, a left-eye image for the original, the black image, a right-eye image for the original and the black image of 480 Hz.

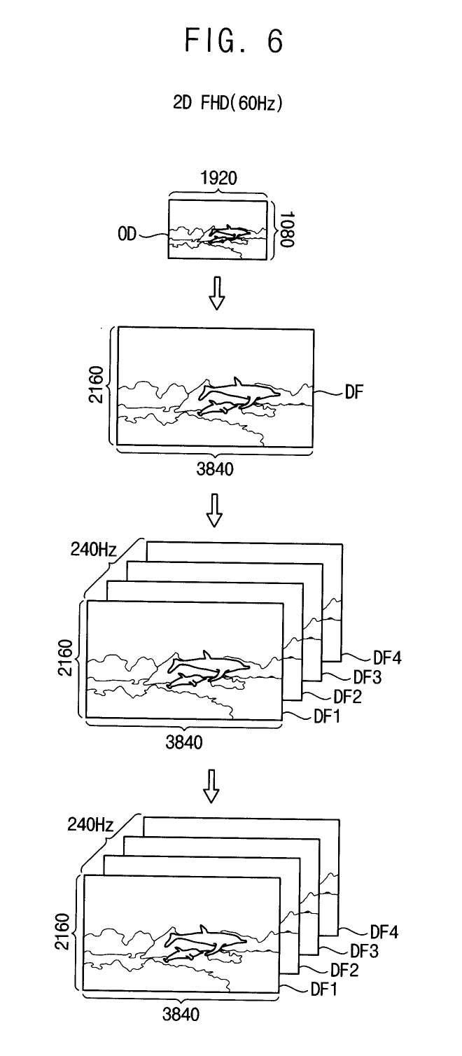

FIG. 6 is a schematic diagram showing an exemplary embodiment of a method of processing 2D image data using the image data processing part of FIG. 1.

Referring to FIGS. 1 and 6, the mode determining part 210 determines that the original data frame OD is the 2D image mode that is 60 Hz and has the resolution of the FHD. Accordingly, the mode determining part 210 controls the scaler 230, the frame rate control part 250 and the timing control part 270.

The scaler 230 scales up the original data frame OD of the FHD in horizontal and vertical directions to generate the data frame DF of the UD and provides the data frame DF to the frame rate control part 250.

The frame rate control part 250 generates 4 data frames using the data frame DF. The 4 data frames include a first data frame DF1, a second data frame DF2, a third data frame DF3 and a fourth data frame DF4. The frame rate control part 250 outputs the first, second, third and fourth data frames DF1, DF2, DF3 and DF4 with 240 Hz to the timing control part 270. Alternatively, the frame rate control part 250 may output the first data frame DF1 for the interpolation, the second data frame DF2 for the original, the third data frame DF3 for the interpolation and the fourth data frame DF4 for the original of 240 Hz using the MEMC method.

The timing control part 270 provides the first, second, third and fourth data frames DF1, DF2, DF3 and DF4 received from the frame rate control part 250 to the data driving part 310.

Meanwhile, when the original data frame OD is the 2D image mode that is the data frame of 60 Hz and has the resolution of the UD, the scaler 230 provides the original data frame OD of the UD to the frame rate control part 250 as it is. Then, the frame rate control part 250 and the timing control part 270 are driven substantially the same as described above referring to FIG. 5.

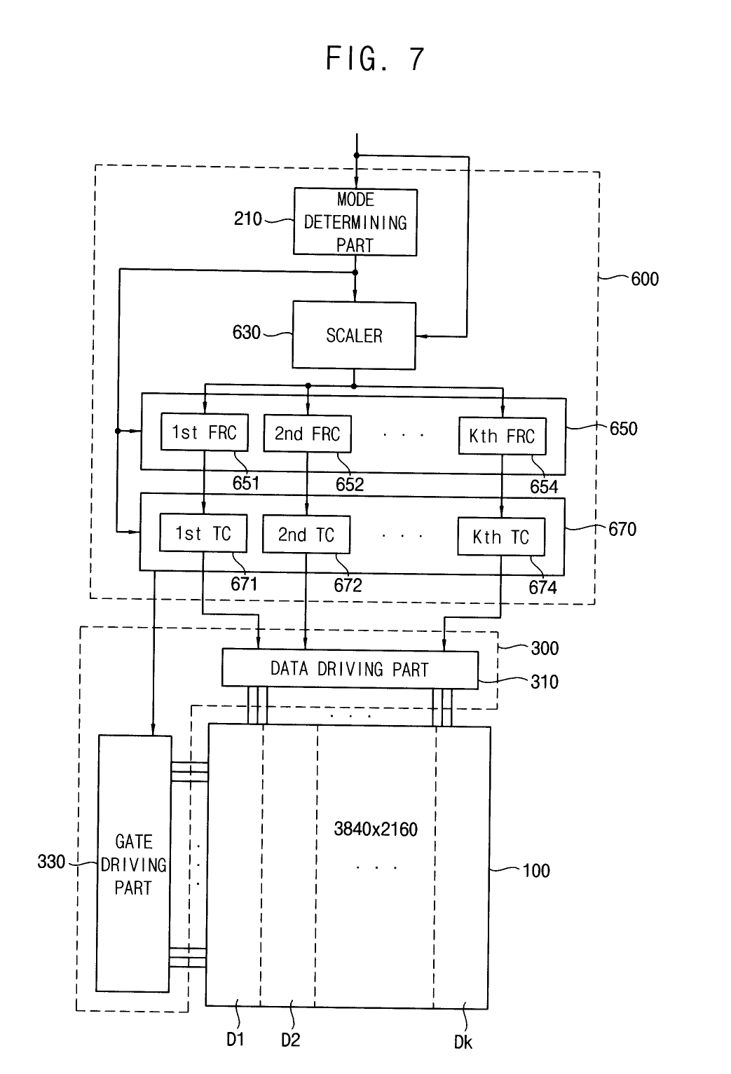

FIG. 7 is a block diagram illustrating another exemplary embodiment of an image data processing part in an exemplary display apparatus according to the present invention.

Referring to FIG. 7, the display apparatus includes a display panel 100, an image data processing part 600 and a panel driving part 300.

The display panel 100 includes a plurality of pixel units corresponding to the UD, and each of the pixel units includes a plurality of color sub pixels. The display panel 100 displays an UD image. A resolution of the UD image may be 3840×2160.

The image data processing part 600 includes a mode determining part 210, a scaler 630, a frame rate control part 650 and a timing control part 670.

The mode determining part 210 receives an original data of an original data frame and determines an image mode of the original data frame. For example, the mode determining part 210 determines the image mode of the original data frame using a synchronization signal, a mode information signal, etc. That is, the mode determining part 210 determines whether the original data frame is a 2D image mode or a 3D image mode. The 2D image mode includes a 2D image mode of the UD and a 2D image mode of the FHD. The 3D image mode includes a 3D image mode of the UD and a 3D image mode of the FHD.

The scaler 630 scales the original data frame based on the image mode determined from the mode determining part 210 so that the resolution of the original data frame may be the UD corresponding to the display panel 100. The scaler 630 spatially divides the scaled data frame into K (herein, K is a natural number not less than 2) data blocks. In a FHD image mode, the scaler 630 scales up the original data frame into the data frame of the UD, and divides the data frame into K data blocks. In a UD image mode, the scaler 630 divides the original data frame of the UD into K data blocks.

The frame rate control part 650 includes K frame rate controllers (“FRCs”) 651, 652, . . . , 654. The FRCs 651, 652, . . . , 654 output M (herein, M is a natural number not less than 4) data frames.

Each of the FRCs 651, 652, . . . , 654, outputs M data blocks using one of the K data blocks received from the scaler 630. For example, the FRC may repeat the received data block to output M data blocks. Alternatively, the FRC may interpolate a data block for an interpolation between a previous data block and a present data block using the MEMC method to output M data blocks including the data block for the interpolation and the present data block for an original.

In the 2D image mode, the first FRC 651 outputs the M data blocks using a first data block of the data frame. In the 3D image mode, the first FRC 651 divides the first data block of the data frame into left-eye image data and right-eye image data. The first FRC 651 respectively scales the left-eye image data and right-eye image data into a left-eye data block and a right-eye data block. The first FRC 651 respectively outputs N left-eye data blocks and N right-eye data blocks (wherein N is a natural number and is M/2) using the left-eye data block and the right-eye data block.

The K FRCs 651, 652, . . . , 654 receive the K data blocks to output (K×M) data blocks. For example, the frame rate control part 650 outputs the data frame including the K data blocks by M times.

The timing control part 670 provides the M data frames to the data driving part 310. The timing control part 670 may include K timing control circuits (TCs) 671, 672, . . . , 674. The first TC 671 receives M first data blocks from the first frame rate controller 651 and provides M first data blocks to at least one of a plurality of driving circuits of the data driving part 310 driving a first display block D1 of the display panel 100. Synchronized with the first TC 671, the second TC 672 receives M second data blocks from the second frame rate controller 652 and provides M second data blocks to at least one of a plurality of driving circuits of the data driving part 310 driving a second display block D2 of the display panel 100. Synchronized with the second TC 672, the K-th TC 674 receives M K-th data blocks from the K-th frame rate controller 654 and provides M K-th data blocks to at least one of a plurality of driving circuits of the data driving part 310 driving a K-th display block DK of the display panel 100.

In the 2D image mode, the timing control part 670 receives the M data frames and provides the M data frames to the data driving part 310. In the 3D image mode, the timing control part 670 generates a black data frame and inserts the black data frame between the left-eye data frame and the right-eye data frame. For example, the timing control part 670 sequentially outputs (N−1) left-eye data frames, a first black data frame, (N−1) right-eye data frames and a second black data frame.

The panel driving part 300 displays a frame image of the UD on the display panel 100 based on the data frame and the control signal received from the timing control part 670. The panel driving part 300 includes a data driving part 310 providing a data signal to a data line of the display panel 100 and a gate driving part 330 providing a gate signal to a gate line of the display panel 100.

For example, in the 2D image mode, the panel driving part 300 displays M frame images corresponding to the original data frame on the display panel 100. In the 3D image mode, the panel driving part 300 displays (N−1) left-eye frame images, the black frame image, (N−1) right-eye frame images and the black frame image corresponding to the original data frame on the display panel 100.

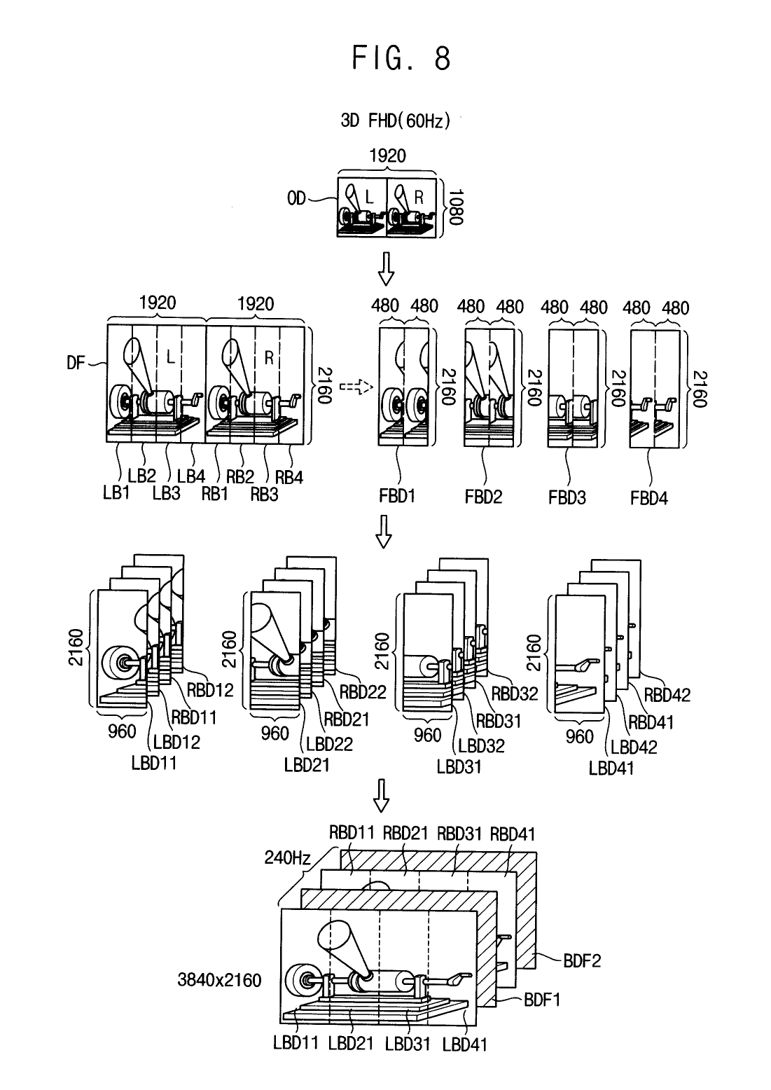

FIG. 8 is a schematic diagram showing an exemplary embodiment of a method of processing 3D image data using the exemplary image data processing part of FIG. 7.

Referring to FIGS. 7 and 8, the mode determining part 210 determines that the original data frame OD is the 3D image mode that is 60 Hz and has the resolution of the FHD. Accordingly, the mode determining part 210 controls the scaler 630, the frame rate control part 650 and the timing control part 670.

The scaler 630 scales up the original data frame OD of the FHD in horizontal and vertical directions to generate a data frame DF of the UD. The data frame DF includes left-eye image data L and right-eye image data R. The left-eye image data L includes a first left-eye block LB1, a second left-eye block LB2, a third left-eye block LB3 and a fourth left-eye block LB4. The right-eye image data R includes a first right-eye block RB1, a second right-eye block RB2, a third right-eye block RB3 and a fourth right-eye block RB4. The scaler 630 spatially divides the data frame DF into 4 data blocks that are a first data block FBD1, a second data block FBD2, a third data block FBD3 and a fourth data block FBD4. The first data block FBD1 includes the first left-eye block LB1 and the first right-eye block RB1. The second data block FBD2 includes the second left-eye block LB2 and the second right-eye block RB2. The third data block FBD3 includes the third left-eye block LB3 and the third right-eye block RB3. The fourth data block FBD4 includes the fourth left-eye block LB4 and the fourth right-eye block RB4.

The frame rate control part 650 receives the first to fourth data blocks FBD1, FBD2, FBD3 and FBD4 from the scaler 630, and outputs (4×4) data blocks using the first to fourth data blocks FBD1, FBD2, FBD3 and FBD4.

In an exemplary embodiment, the first frame rate controller 651 time-divides the first data block FBD1 into the first left-eye block LB1 and the first right-eye block RB1. The first frame rate controller 651 scales up the first left-eye block LB1 to generate a first left-eye data block LBD11 and generates a second left-eye data block LBD12 using the first left-eye data block LBD11. In addition, the first frame rate controller 651 scales up the first right-eye block RB1 to generate the first right-eye data block RBD11 and generates a second right-eye data block RBD12 using the first right-eye data block RBD11. The first frame rate controller 651 outputs the first left-eye data block LBD11, the second left-eye data block LBD12, the first right-eye data block RBD11 and the second right-eye data block RBD12 to the timing control part 670. The first frame rate controller 651 repeats the first data block to generate the second data block or generates the second data block for the interpolation based on the first data block by the MEMC method.

By the above-described method, a second frame rate controller 652 generates a first left-eye data block LBD21, a second left-eye data block LBD22, a first right-eye data block RBD21 and a second right-eye data block RBD22 using the second data block FBD2. A third frame rate controller 653 generates a first left-eye data block LBD31, a second left-eye data block LBD32, a first right-eye data block RBD31 and a second right-eye data block RBD32 using the third data block FBD3. A fourth frame rate controller 654 generates a first left-eye data block LBD41, a second left-eye data block LBD42, a first right-eye data block RBD41 and a second right-eye data block RBD42 using a fourth data block FBD4.

The timing control part 670 receives the left-eye data blocks LBD and the right-eye data blocks RBD from the frame rate control part 650 to provide the data driving part 310 with the left-eye data blocks LBD and the right-eye data blocks RBD. The timing control part 670 generates a black data frame to provide the black data frame to the data driving part 310. For example, the timing control part 670 receives 4 first left-eye data blocks LBD11, LBD21, LBD31 and LBD41 to output the 4 first left-eye data blocks LBD11, LBD21, LBD31 and LBD41 to the data driving part 310. The timing control part 670 generates the first black data frame BDF1 to output to the data driving part 310. The timing control part 670 receives 4 first right-eye data blocks RBD11, RBD21, RBD31 and RBD41 to output the 4 first right-eye data blocks RBD11, RBD21, RBD31 and RBD41 to the data driving part 310. The timing control part 670 generates the second black data frame BDF2 to output the second black data frame BDF2 to the data driving part 310.

Therefore, the display panel 100 may display a left-eye frame image, a black frame image, a right-eye frame image and a black frame image with 240 Hz.

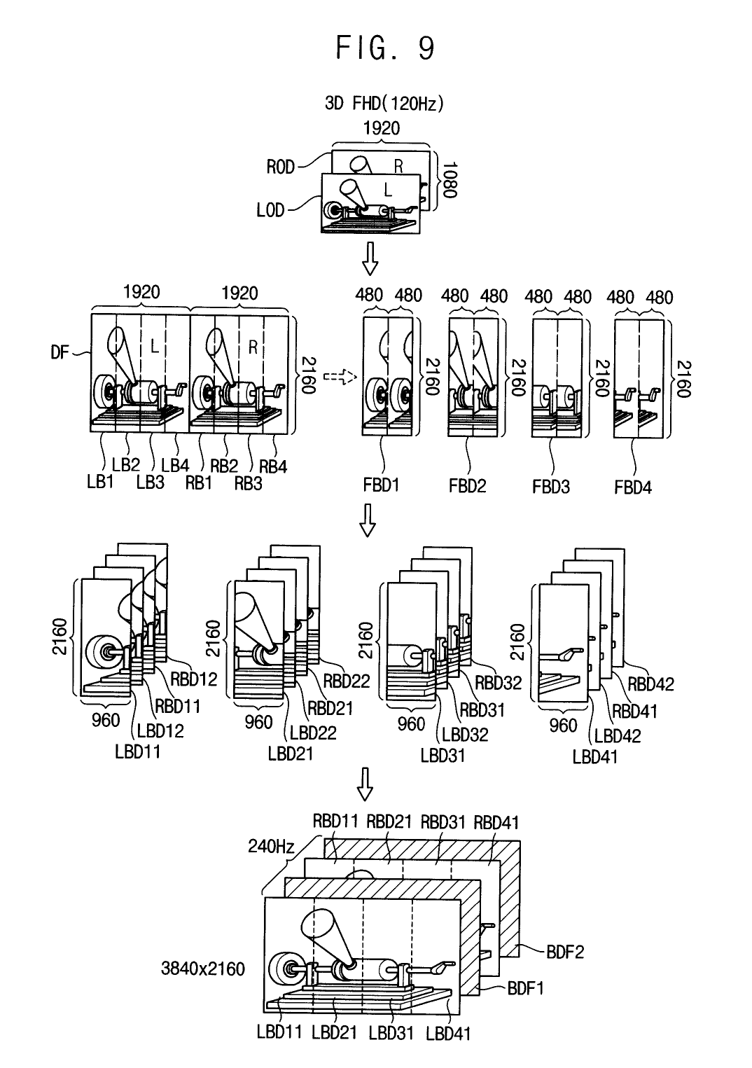

FIG. 9 is a schematic diagram showing another exemplary embodiment of a method of processing 3D image data using the image data processing part of FIG. 7.

Referring to FIGS. 7 and 9, the mode determining part 210 determines that the original data frame OD is the 3D image mode that is 120 Hz and has the resolution of the FHD. Accordingly, the mode determining part 210 controls the scaler 630, the frame rate control part 650 and the timing control part 670.

The scaler 630 stores the left-eye original data frame LOD and the right-eye original data frame ROD of 120 Hz having the resolution of the FHD. The scaler 630 composes the left-eye original data frame LOD with the right-eye original data frame ROD to generate a composed image data. The scaler 630 scales up the composed image data into the data frame DF having the resolution of the UD. The data frame DF includes left-eye image data L and right-eye image data R. The left-eye image data L includes a first left-eye block LB1, a second left-eye block LB2, a third left-eye block LB3 and a fourth left-eye block LB4. The right-eye image data R includes a first right-eye block RB1, a second right-eye block RB2, a third right-eye block RB3 and a fourth right-eye block RB4. The scaler 630 spatially divides the data frame DF into 4 data blocks that are a first data block FBD1, a second data block FBD2, a third data block FBD3 and a fourth data block FBD4. The first data block FBD1 includes the first left-eye block LB1 and the first right-eye block RB1. The second data block FBD2 includes the second left-eye block LB2 and the second right-eye block RB2. The third data block FBD3 includes the third left-eye block LB3 and the third right-eye block RB3. The fourth data block FBD4 includes the fourth left-eye block LB4 and the fourth right-eye block RB4.

As described above with reference to FIG. 8, the frame rate control part 650 receives the first to fourth data blocks FBD1, FBD2, FBD3 and FBD4 from the scaler 630 and outputs (4×4) data blocks using the first to fourth data blocks FBD1, FBD2, FBD3 and FBD4, and provides the (4×4) data blocks to the timing control part 670.

The timing control part 670 provides the data driving part 310 with first left-eye data blocks LBD11, LBD21, LBD31 and LBD41, a first black data frame BDF1, first right-eye data blocks RBD11, RBD21, RBD31 and RBD41 and a second black data frame BDF2.

Therefore, the display panel 100 may display a left-eye frame image, a black frame image, a right-eye frame image and a black frame image with 240 Hz.

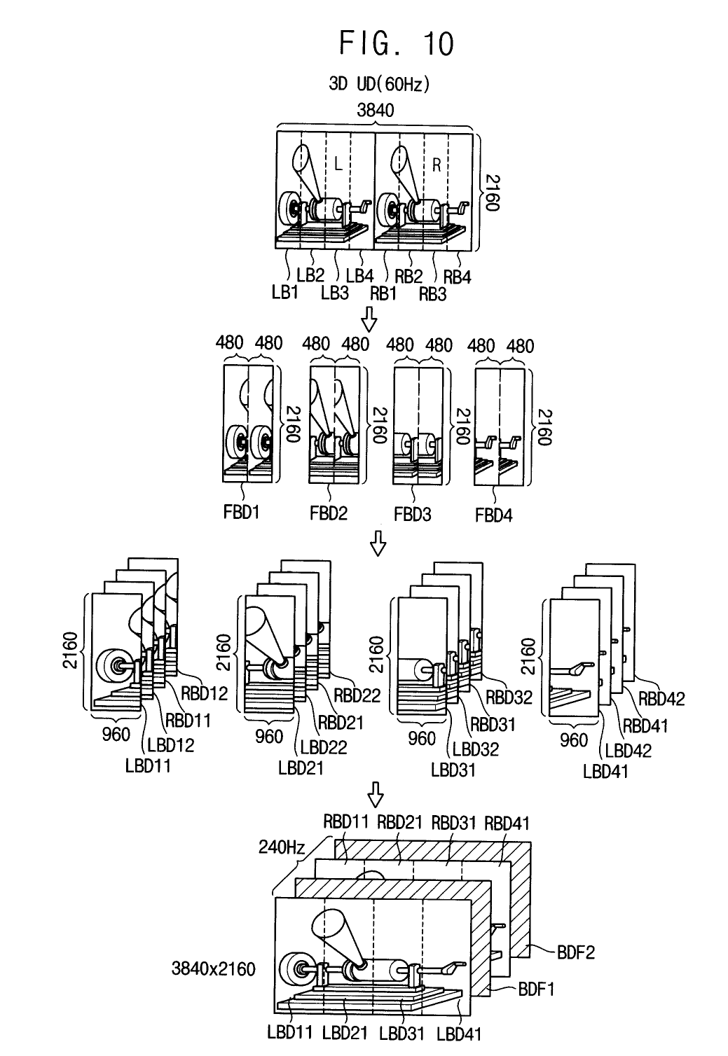

FIG. 10 is a schematic diagram showing another exemplary embodiment of a method of processing 3D image data using the image data processing part of FIG. 7.

Referring to FIGS. 7 and 10, the mode determining part 210 determines that the original data frame OD is the 3D image mode that is 60 Hz and has the resolution of the UD. Accordingly, the mode determining part 210 controls the scaler 630, the frame rate control part 650 and the timing control part 670.

The scaler 630 spatially divides the original data frame OD into 4 data blocks FBD1, FBD2, FBD3 and FBD4. In an exemplary embodiment, the original data frame OD includes left-eye image data L and right-eye image data R. The left-eye image data L includes a first left-eye block LB1, a second left-eye block LB2, a third left-eye block LB3 and a fourth left-eye block LB4. The right-eye image data R includes a first right-eye block RB1, a second right-eye block RB2, a third right-eye block RB3 and a fourth right-eye block RB4. The scaler 630 divides the original data frame OD into the first data block FBD1, the second data block FBD2, the third data block FBD3 and the fourth data block FBD4. The first data block FBD1 includes the first left-eye block LB1 and the first right-eye block RB1. The second data block FBD2 includes the second left-eye block LB2 and the second right-eye block RB2. The third data block FBD3 include the third left-eye block LB3 and the third right-eye block RB3. The fourth data block FBD4 includes the fourth left-eye block LB4 and the fourth right-eye block RB4.

As described above with reference to FIG. 8, the frame rate control part 650 receives the first to fourth data blocks FBD1, FBD2, FBD3 and FBD4 from the scaler 630, and outputs (4×4) data blocks using the first to fourth data blocks FBD1, FBD2, FBD3 and FBD4.

The timing control part 670 receives the (4×4) data blocks from the frame rate control part 650 and provides the data driving part 310 with first left-eye data blocks LBD11, LBD21, LBD31 and LBD41, a first black data frame BDF1, first right-eye data blocks RBD11, RBD21, RBD31 and RBD41 and a second black data frame BDF2.

Therefore, the display panel 100 may display a left-eye frame image, a black frame image, a right-eye frame image and a black frame image with 240 Hz.

When the original data frame OD is the 3D image mode that is the data frame of 120 Hz and has the resolution of the UD, the scaler 630 stores a left-eye original data frame and a right-eye original data frame of the UD and composes the left-eye original data frame with the right-eye original image data. The scaler 630 scales down the composed image data into the data frame having the resolution of the UD. In an alternative exemplary embodiment, the scaler 630 scales down the left-eye original data frame and the right-eye original data frame and composes the scaled left-eye image data with the scaled right-eye image data to generate a composed data frame of the UD. Then, the frame rate control part 650 and the timing control part 670 are driven substantially the same as described above with reference to FIG. 10.

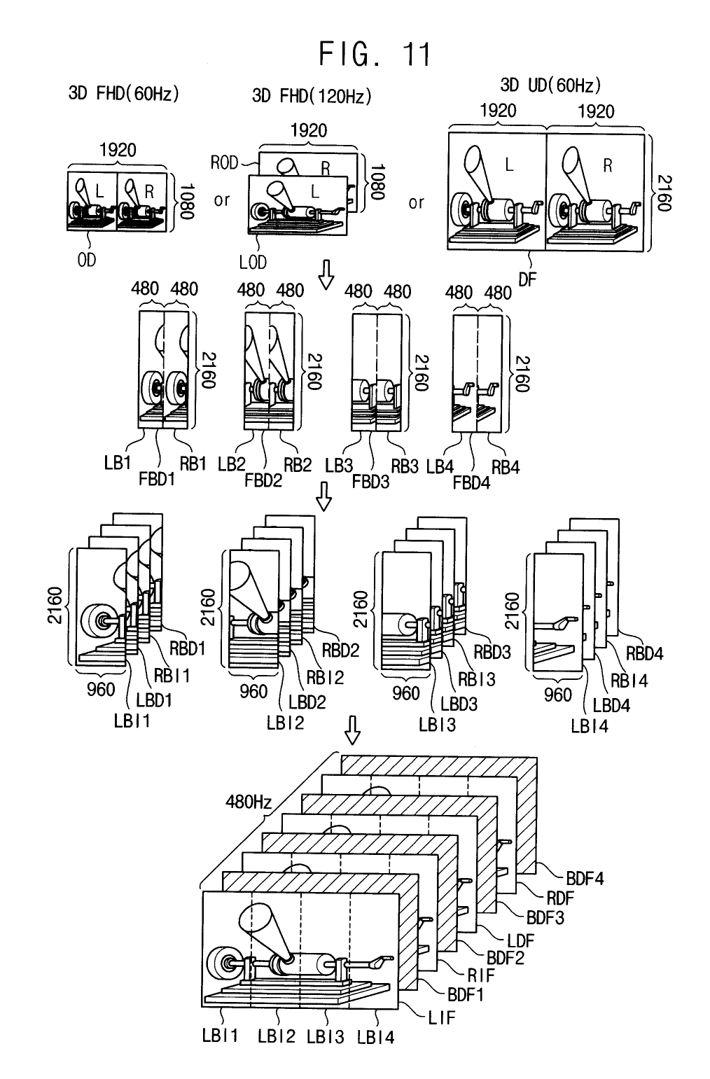

FIG. 11 is a schematic diagram showing another exemplary embodiment of a method of processing 3D image data using the image data processing part of FIG. 7. Hereinafter, the same reference numerals will be used to refer to the same or like parts as those described in the previous example embodiment, and any repetitive detailed explanation will be simplified.

Referring to FIGS. 7 and 11, the mode determining part 210 controls a scaler 630, a frame rate control part 650 and a timing control part 670 according to an image mode of the received original image data,

The original image data may be at least one of the 3D FHD of 60 Hz, the 3D FHD of 120 Hz and the 3D UD of 60 Hz as described above with reference to FIGS. 8, 9 and 10.

When the original image data is the 3D FHD as described above with reference to FIG. 8 or 9, the scaler 630 scales the original image data into a data frame DF of the UD and spatially divides the data frame DF into four data blocks that are a first data block FBD1, a second data block FBD2, a third data block FBD3 and a fourth data block FBD4.

Alternatively, when the original image data is the data frame DF of the UD as described above with reference to FIG. 10, the scaler 630 spatially divides the data frame DF into four data blocks that are a first data block FBD1, a second data block FBD2, a third data block FBD3 and a fourth data block FBD4.

The frame rate control part 650 receives the first to fourth data blocks FBD1, FBD2, FBD3 and FBD4 and outputs 4×4 data blocks using the first to fourth data blocks FBD1, FBD2, FBD3 and FBD4.

For example, a first frame rate controller 651 time-divides the first data block FBD1 into the first left-eye block LB1 and the first right-eye block RB1. The first frame rate controller 651 scales up the first left-eye block LB1 to generate a first left-eye data block LBD1 for an original and generates a first left-eye data block LBI1 for an interpolation corresponding to the first left-eye data block LBD1 for the original using the MEMC method. In addition, the first frame rate controller 651 scales up the first right-eye block RB1 to generate a first right-eye data block RBD1 for an original and generates a first right-eye data block RBI1 for an interpolation corresponding to the first right-eye data block RBD1 for the original using the MEMC method. The first frame rate controller 651 outputs the first left-eye data block LBI1 for the interpolation, the first left-eye data block LBD1 for the original, the first right-eye data block RBI1 for the interpolation and the first right-eye data block RBD1 for the original.

As described above, a second frame rate controller 652 outputs a second left-eye data block LBI2 for the interpolation, a second left-eye data block LBD2 for the original, a second right-eye data block RBI2 for the interpolation and a second right-eye data block RBD2 for the original using the second data block FBD2, a third frame rate controller 653 outputs a third left-eye data block LBI3 for the interpolation, a third left-eye data block LBD3 for the original, a third right-eye data block RBI3 for the interpolation and a third right-eye data block RBD3 for the original using the third data block FBD3, and a fourth frame rate controller 654 outputs a fourth left-eye data block LBI4 for the interpolation, a fourth left-eye data block LBD4 for the original, a fourth right-eye data block RBI4 for the interpolation and a fourth right-eye data block RBD4 for the original using the fourth data block FBD4.

The timing control part 270 generates a black data frame and inserts the black data frame between a left-eye frame and a right-eye frame. The timing control part 270 outputs the first to fourth left-eye data blocks LBI1, LBI2, LBI3 and LBI4 for the interpolation corresponding to the left-eye data frame LIF for the interpolation in synchronization with each other, outputs a first black data frame BDF1, outputs the first to fourth right-eye data blocks RBI1, RBI2, RBI3 and RBI4 for the interpolation corresponding to the right-eye data frame RIF for the interpolation in synchronization with each other, outputs a second black data frame BDF2, outputs the first to fourth left-eye data blocks LBD1, LBD2, LBD3 and LBD4 for the original corresponding to the left-eye data frame LDF for the original in synchronization with each other, outputs a third black data frame BDF3, outputs the first to fourth right-eye data blocks RBD1, RBD2, RBD3 and RBD4 for the original corresponding to the right-eye data frame RDF for the original in synchronization with each other, and outputs a fourth black data frame BDF4.

Accordingly, the display panel 100 may sequentially display a left-eye image for the interpolation, a black image, a right-eye image for the interpolation, the black image, a left-eye image for the original, the black image, a right-eye image for the original and the black image of 480 Hz.

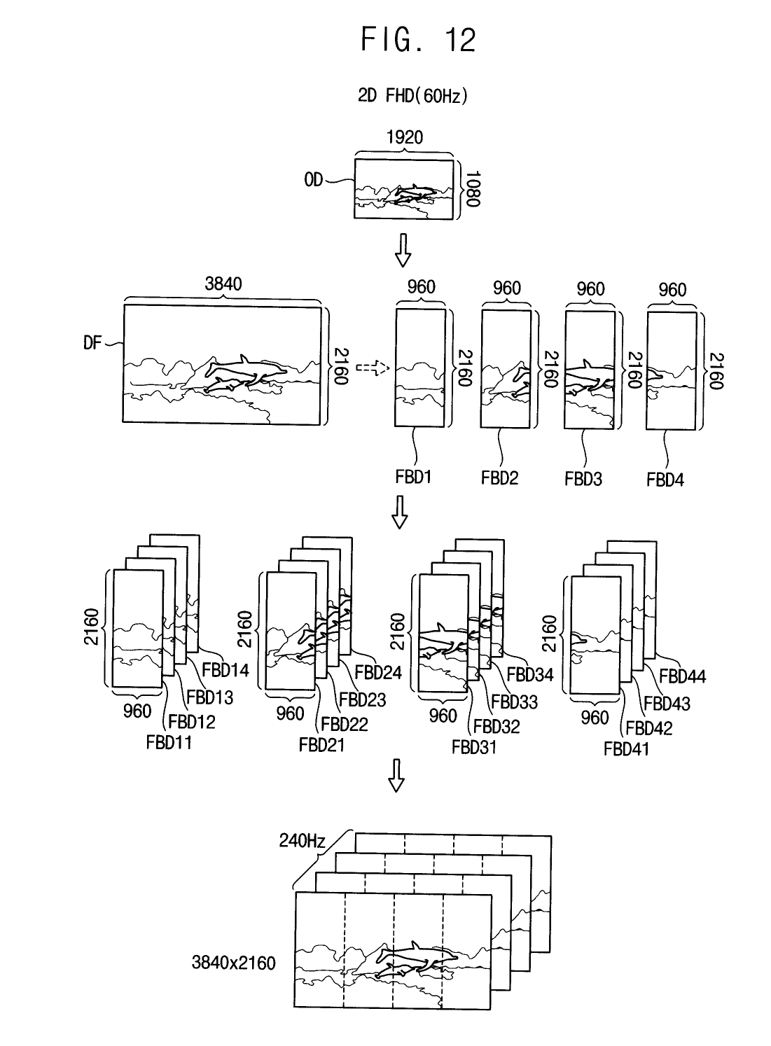

FIG. 12 is a schematic diagram showing an exemplary embodiment of a method of processing 2D image data using the image data processing part of FIG. 7.

Referring to FIGS. 7 and 12, the mode determining part 210 determines that the original data frame OD is the 2D image mode that is 60 Hz and has the resolution of the FHD. Accordingly, the mode determining part 210 controls the scaler 630, the frame rate control part 650 and the timing control part 670.

The scaler 630 scales up the original data frame of the FHD in horizontal and vertical directions to generate a data frame DF of the UD. The scaler 630 divides the data frame DF into a first data block FBD1, a second data block FBD2, a third data block FBD3 and a fourth data block FBD4.

The frame rate control part 650 receives the first to the fourth data blocks FBD1, FBD2, FBD3 and FBD4 from the scaler 630 and outputs (4×4) data blocks using the first to fourth data blocks FBD1, FBD2, FBD3 and FBD4. A first frame rate controller 651 outputs 4 data blocks FBD11, FBD12, FBD13 and FBD14 using the first data block FBD1. A second frame rate controller 652 outputs 4 data blocks FBD21, FBD22, FBD23 and FBD24 using the second data block FBD2. A third frame rate controller 653 outputs 4 data blocks FBD31, FBD32, FBD33 and FBD34 using the third data block FBD3. A fourth frame rate controller 654 outputs 4 data blocks FBD41, FBD42, FBD43 and FBD44 using the fourth data block FBD4. For example, the first frame rate controller 651 repeats the first data block FBD1 by three times so that four data blocks FBD11, FBD12, FBD13 and FBD14 may be outputted the first frame rate controller 651. Alternatively, the first frame rate controller 651 generates three data blocks for the interpolation based on the first data block FBD1 by the MEMC method so that four data blocks FBD11, FBD12, FBD13 and FBD14 may be outputted from the first frame rate controller 651. The timing control part 670 receives the (4×4) data blocks from the frame rate control part 650 and provides the (4×4) data blocks to the data driving part 310. For example, the timing control part 670 receives 4 data blocks FBD11, FBD21, FBD31 and FBD41 and provides 4 data blocks FBD11, FBD21, FBD31 and FBD41 to the data driving part 310. Then, the timing control part 670 receives 4 data blocks FBD12, FBD22, FBD32 and FBD42 and provides 4 data blocks FBD12, FBD22, FBD32 and FBD42 to the data driving part 310. Then, the timing control part 670 receives 4 data blocks FBD13, FBD23, FBD33 and FBD43 and provides 4 data blocks FBD13, FBD23, FBD33 and FBD43 to the data driving part 310. Then, the timing control part 670 receives 4 data blocks FBD14, FBD24, FBD34 and FBD44 and provides 4 data blocks FBD14, FBD24, FBD34 and FBD44 to the data driving part 310. Therefore, the display panel 100 may display 4 frame images with 240 Hz.

When the original data frame OD is the 2D image mode that is the data frame of 60 Hz and has the resolution of the UD, the scaler 630 divides the original data frame OD into a first data block FBD1, a second data block FBD2, a third data block FBD3 and a fourth data block FBD4. Then, the frame rate control part 650 and the timing control part 670 are driven substantially the same as described above with reference to FIG. 10.

According to exemplary embodiments of the present invention, the original data frame having the resolution of the FHD or the UD may be displayed on the display panel having the resolution of the UD. The low resolution of the original image data and the high resolution of the display panel are not limited to the previous described exemplary embodiments and may be preset variously.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A method of processing an image data, the method comprising:
generating a data frame that has a high resolution using an original image data of a low resolution lower than the high resolution; and
outputting M (herein, M is a natural number not less than 4) data frames using the data frame of the high resolution.

2. The method of claim 1, further comprising:
outputting the M data frames using an original data frame when the original data frame has the high resolution.

3. The method of claim 1, wherein generating the data frame comprises:
composing left-eye image data of the original image data with right-eye image data of the original image data to generate composed image data; and
generating the data frame that has the high resolution using the composed image data.

4. The method of claim 1, wherein outputting M data frames comprises:
scaling left-eye data of the data frame into a left-eye data frame of the high resolution;
outputting the left-eye data frame into N (herein, N is a natural number and is M/2) left-eye data frames;
scaling right-eye data of the data frame into a right-eye data frame of the high resolution; and
outputting the right-eye data frame into N right-eye data frames.

5. The method of claim 4, further comprising:
generating a black data frame that is respectively inserted between the left-eye data frame and the right-eye data frame.

6. The method of claim 1, further comprising:
dividing the data frame of the high resolution into K (herein, K is a natural number not less than 2) data blocks.

7. The method of claim 6, wherein outputting M data frames comprises:
outputting M data blocks respectively corresponding to the K data blocks.

8. The method of claim 6, wherein outputting M data frames comprises:
scaling left data of each of the K data blocks into a left-eye data block;
outputting K left-eye data blocks into (K×N) left-eye data blocks(herein, N is a natural number and is M/2);
scaling right data of each of the K data blocks into a right-eye data block; and
outputting K right-eye data blocks into (K×N) right-eye data blocks.

9. The method of claim 8, further comprising:
generating a black data frame that is respectively inserted between a left-eye data frame having K left-eye data blocks and a right-eye data frame having K right-eye data blocks.

10. A display apparatus comprising:
a display panel including a plurality of pixel units corresponding to a high resolution;
an image data processing part generating a data frame of the high resolution using an original data frame of a low resolution lower than the high resolution and outputting M (herein, M is a natural number not less than 4) data frames using the data frame of the high resolution; and
a panel driving part displaying M frame images on the display panel using the M data frames.

11. The display apparatus of claim 10, wherein the image data processing part comprises:
a scaler generating the data frame of the high resolution using the original data frame; and
a frame rate control part outputting M data frames using the data frame of the high resolution.

12. The display apparatus of claim 11, wherein the frame rate control part outputs the M data frames using the original data frame when the original data frame is the data frame of the high resolution.

13. The display apparatus of claim 11, wherein the scaler composes left-eye image data of the original data frame with right-eye image data of the original data frame to generate composed image data, and scales the composed image data into the data frame of the high resolution.

14. The display apparatus of claim 11, wherein the frame rate control part scales left-eye data of the data frame into a left-eye data frame of the high resolution, outputs the left-eye data frame into N (herein, N is a natural number and is M/2) left-eye data frames, scales right-eye data of the data frame into a right-eye data frame of the high resolution, and outputs the right-eye data frame into N right-eye data frames.

15. The display apparatus of claim 14, wherein the image data processing part further includes a timing control part generating a black data frame that is respectively inserted between the left-eye data frame and the right-eye data frame.

16. The display apparatus of claim 11, wherein the frame rate control part includes K (herein, K is a natural number not less than 2) frame rate controllers.

17. The display apparatus of claim 16, wherein the scaler divides the data frame of the high resolution into K data blocks and provides the K data blocks to the K frame rate controllers.

18. The display apparatus of claim 17, wherein the K frame rate controllers output M data blocks respectively corresponding to the K data blocks.

19. The display apparatus of claim 17, wherein the K frame rate controllers scale left data of each of the K data blocks into a left-eye data block, output K left-eye data blocks into (K×N) left-eye data blocks (herein, N is a natural number and is M/2), scale right data of each of the K data blocks into a right-eye data block, and output K right-eye data blocks into (K×N) right-eye data blocks.

20. The display apparatus of claim 19, wherein the image data processing part further includes a timing control part generating a black data frame that is respectively inserted between a left-eye data frame having the K left-eye data blocks and a right-eye data frame having the K right-eye data blocks.
